(19) United States
(12) Patent Application Publication
(10) Pub. No.: US 2006/0269455 A1
(43) Pub. Date: Nov. 30, 2006

(54) Apparatus for large-scale dispersion of essential oils

(75) Inventor: Timothy W. Planker, Cape Coral, FL (US)

Correspondence Address: ARENT FOX PLLC, 1050 CONNECTICUT AVENUE, N.W., SUITE 400, WASHINGTON, DC, 20036, US

(73) Assignee: Hinsilblon Ltd.

(21) Appl. No.: 11/301,250

(22) Filed: Dec. 13, 2005

Related U.S. Application Data
(60) Provisional application No. 60/634,990, filed on Dec. 13, 2004.

(51) Int. Cl. A62B 7/08

(52) U.S. Cl. 422/123

(57) ABSTRACT

A large scale vapor dispersion apparatus for dispersing a vapor of essential oil without the use of water by forcing an air stream through and/or over a volume of the essential oil, vaporizing a portion of the essential oil, controlling the vaporization rate by increasing or decreasing the amount of heated air passing through the essential oil, and distributing the air and vapor mixture over a large scale space. The apparatus also includes the capability to deodorize the air by passing the air through a scavenging fluid. The apparatus includes a blower or vacuum pump, a reservoir, piping joining the blower or vacuum pump to the reservoir, a bypass valve for directing a portion of the air above a surface of the essential oil or outside of the reservoir, and a vapor dispersing device for dispersing the air and vapor exhausted from the apparatus into a large space.

### CROSS-REFERENCE TO RELATED APPLICATIONS

This application claims the benefit of U.S. Provisional Application No. 60/634,990, filed Dec. 13, 2004, which is incorporated herein by reference in its entirety.

### BACKGROUND OF THE INVENTION

1. Field of the Invention

The present invention relates to an apparatus for deodorizing a stream of gas (also interchangeably referred to herein as “air”) and for large-scale dispersion of vaporized essential oils into large open spaces or volumes without the use of water.

2. Background of the Technology

Dispersion of vaporized essential oils into a large space without the use of water is known in the art, for example, by U.S. Pat. No. 6,142,383 issued to Timothy W. Planker, the contents of which are hereby incorporated by reference in its entirety. Additionally, U.S. Pat. No. 6,423,274 also issued to Timothy W. Planker, which is hereby incorporated by reference in its entirety, relates to an apparatus for deodorizing gas by passing the gas over a surface of a deodorizing liquid.

Although devices are known for dispersing essential oils, the devices vaporize oil exclusively by forcing a volume of air over a surface of the oil in order to vaporize or otherwise entrain the oil in the gas for subsequent dispersal or by atomizing the oil into a stream of air. While effective in some application, there exists a need to deodorize and/or disperse essential oils at a higher rate or in higher concentrations than the presently available devices can supply. There is also a need to deodorize an air stream by passing the air stream through a deodorizing liquid, such as an essential oil and a scavenging fluid.

### SUMMARY OF THE INVENTION

The present invention solves these problems, as well as other, by forcing air through a volume of essential oil in order to vaporize or entrain a higher concentration of the essential oil in the air. Further, the present invention provides for the vaporization and widespread dispersion of essential oils without necessarily using water.

According to a first aspect of the present invention, the apparatus of the present invention disperses essential oil by vaporizing a super concentrated liquid essential oil in one of two modes controlled by adjusting a bypass valve between an open and closed position.

The first mode involves purely convective vaporization by forcing heated air over a surface of the liquid essential oil contained in a reservoir. The air vaporizes a portion of the liquid essential oil, wherein the resulting mixture of air and essential oil vapor is exhausted from the reservoir through an outlet and dispersed by a vapor dispersing device, such as a perforated hose or nozzle. The second mode involves both convective vaporization as well as vaporization by forcing air through the liquid essential oil. The second mode may be initiated by opening a bypass valve, for example. The resulting mixture of air and essential oil vapor is then exhausted through the outlet of the reservoir and dispersed by the vapor dispersing device. The present invention increases vaporization efficiency by directing the entire volume of air within the apparatus through the reservoir containing the essential oil regardless of the position of the bypass valve as opposed to forcing a portion of the air outside the reservoir when the bypass valve is opened.

According to a second aspect of the present invention, the apparatus of the present invention deodorizes a flow of air used for dispersing the essential oils. The apparatus passes at least a portion of the airflow through a scavenging fluid, such as caustic (e.g., NaOH), bleach, trizene, or any other fluid capable of removing obnoxious gases from an airflow, such as H₂S. The airflow then passes through an essential oil, causing a portion of the essential oil to be entrained in the air. The airflow then exits the apparatus through a vapor dispersing device, such as an exhaust pipe, one or more nozzles, or a perforated hose. A vacuum pump creates the airflow. The apparatus is useful in deodorizing air emanating, for example, from a pumping station of a wastewater treatment plant or air generated by the transport of sewage, such as when sewage is removed from a septic tank.

Additional advantages of the present invention include a low capital cost, ease of maintenance, and technological simplicity so as not to require a sophisticated electronic controller. Further, because no water is used in dispersing the essential oil and the freezing point of essential oil is well below −100° F., the apparatus of the present invention allows winter operation.

Additional aspects, advantages, and novel features of the invention will be better understood as set forth in the following description and accompanying drawings and will also become apparent to those skilled in the art upon examination of the following or upon learning by practice of the invention.

### BRIEF DESCRIPTION OF THE FIGURES

The features of the invention will be more readily understood with reference to the following description and the attached drawings, wherein:

FIGS. 1(a), 1(b), and 1(c) show a side view of an apparatus according to a first embodiment of the present invention;

FIG. 2 shows is a perforated hose for dispersing a vapor within a large space for use with the apparatus according to the present invention;

FIG. 3 shows a nozzle for dispersing a vapor within a large space for use with the apparatus according to the present invention;

FIG. 4 shows the apparatus according to the first embodiment of the present invention contained within a housing for ease of transportation;

FIG. 5 shows the apparatus according to the first embodiment of the present invention having a plurality of nozzles for dispersing the vapor;

FIGS. 6(a) and 6(b) show the apparatus according to the first embodiment of the present invention having a vertical configuration;

FIG. 7 is a cross-sectional view of the reservoir according to the first embodiment of the present invention containing scrubber packing;

FIG. 8 is a side view of an apparatus according to a second embodiment of the present invention;

FIG. 9 is a top view of a reservoir according to the second embodiment of the present invention;

FIG. 10 is a cross-sectional view of the reservoir according to the second embodiment of the present invention;

FIG. 11 is a top view of an air sparger according to the second embodiment of the present invention;

FIG. 12 is a side view of an apparatus according to a third embodiment of the present invention; and

FIG. 13 is a cross-sectional view of a reservoir according to the third embodiment of the present invention.

### DETAILED DESCRIPTION

Corresponding features of different embodiments described herein are identified with the same reference numbers.

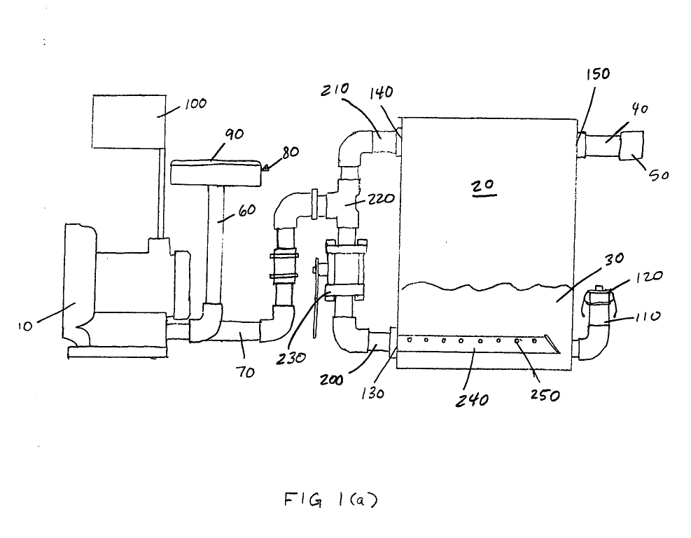

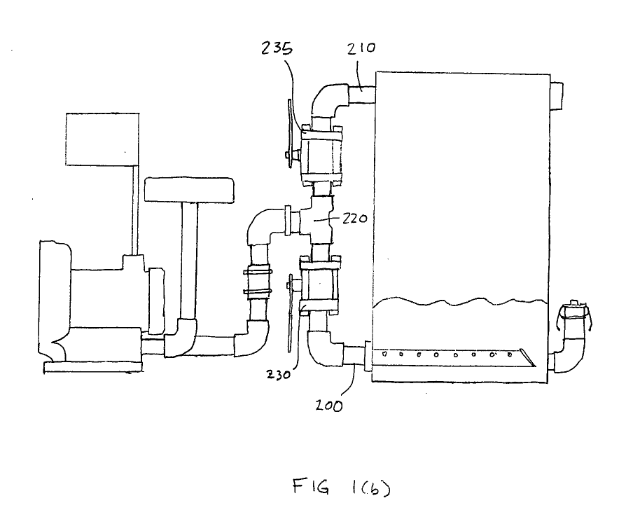

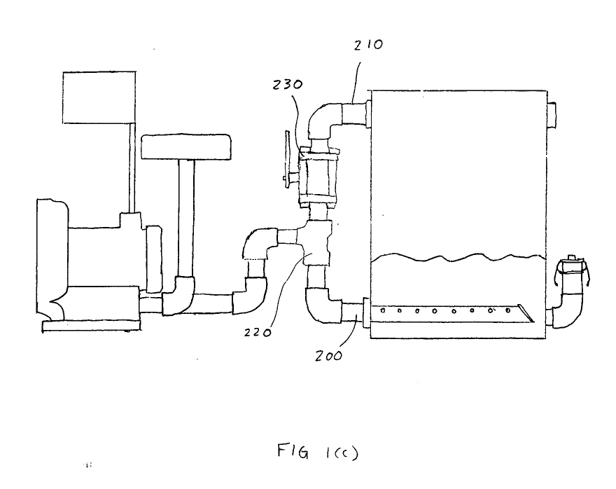

FIG. 1(a) illustrates an improved apparatus for the vaporization and widespread dispersion of essential oils without the use of water according to a first embodiment of the present invention. As shown in FIG. 1(a), the apparatus includes an air blower 10, such as a regenerative air blower, a reservoir 20 for containing a volume of essential oil 30 (referred to hereinafter as “oil 30”), piping for routing air through the apparatus, an exhaust pipe 40, and a vapor dispersing device 50. An air inlet pipe 60 is attached at one end to an inlet of the air blower 10, and an outlet pipe 70 is attached at one end to an outlet of the air blower 10. An air filter 80 is affixed to a second end of the air inlet pipe 60, opposite the air blower 10. The air filter 80 contains, for example, a standard replaceable, pleated paper filter cartridge that is enclosed at a top of the air filter 80 by a standard air filter cover 90. A control panel 100 controls the air blower 10. Although FIG. 1(a) illustrates the control panel 100 as being separate from the air blower 10, it is within the scope of the present invention that the control panel 100 could be directly attached to the air blower 10.

The reservoir 20 is an enclosure that entirely encloses a volume. The reservoir 20 may have any suitable shape, such as a box, a cylinder, a sphere, a pyramid, or any other shape. A volume of oil 30 is contained within the reservoir 20. A fill port 110, having a fill port cap 120 attached at one end, extends from the reservoir 20 for introducing a volume of oil 30 into the reservoir 20. When the fill port cap 120 is removed, the interior of the reservoir 20 freely communicates with the exterior of the reservoir 20 via the fill port 110.

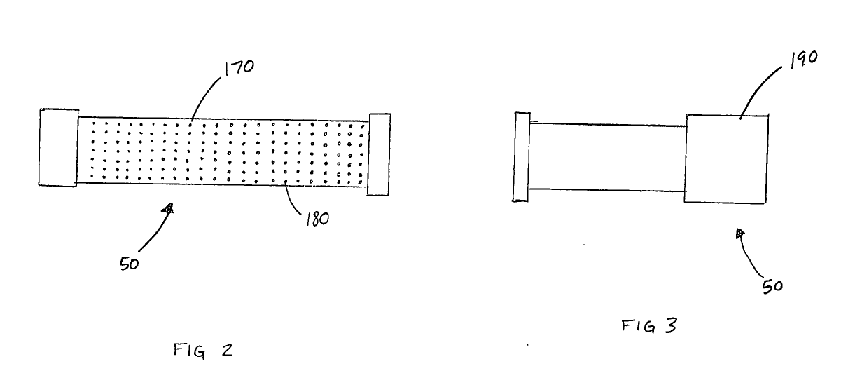

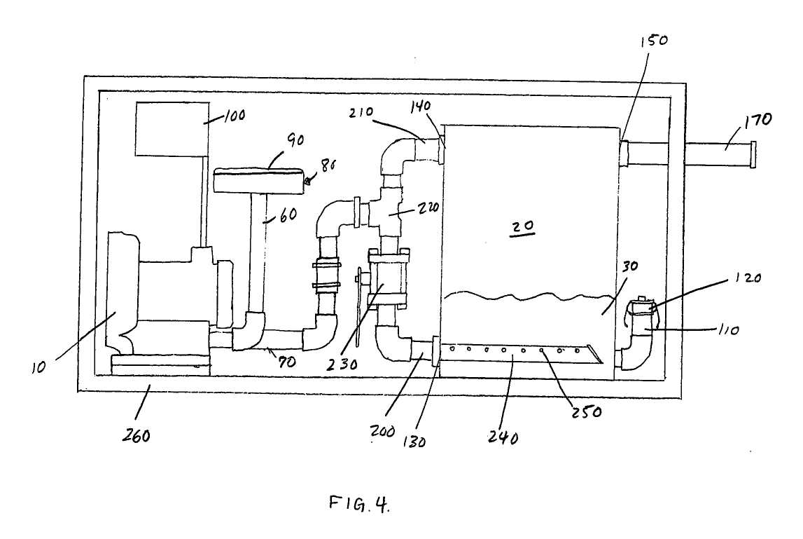

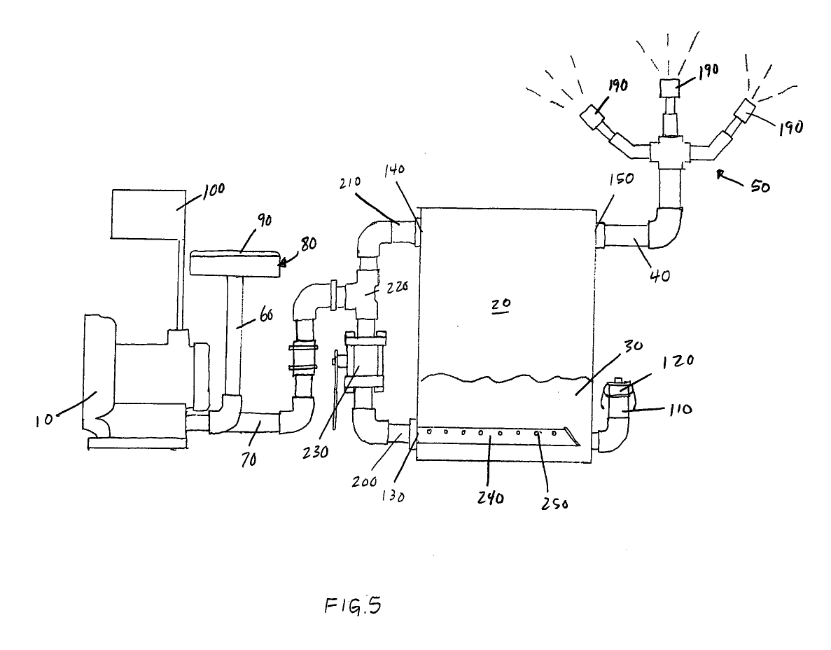

The reservoir 20 also includes a first opening 130 located in a lower portion of the reservoir 20, a second opening 140 located in an upper portion of the reservoir 20, and an outlet 150 located at an upper portion of the reservoir 20. Both the second opening 140 and the outlet 150 are located above a surface or fill level of the oil 30. An exhaust pipe 40 attaches at a first end to the outlet 150. A vapor dispersing device 50 for dispersing vaporized oil 30 in a fog-like manner attaches to a second end of the exhaust pipe 40. Alternatively, the vapor dispersing device 50 attaches directly to the outlet 150, for example. FIGS. 2 and 3 illustrate example embodiments of the vapor dispersing device 50. In FIG. 2, the vapor dispersing device 50 is a perforated hose 170 having numerous small openings 180, wherein each opening 180 provides communication between the interior and exterior of the perforated hose 170. In FIG. 3, the vapor dispersing device 50 is a nozzle 190, such as those manufactured by Bete Fog Nozzle Co. The nozzle 190 includes, for example, a ¼ inch nozzle orifice and is made of polypropylene, for example. FIG. 4 illustrates an alternate embodiment of the vapor dispersing device 50 comprising multiple nozzles 190 to increase dispersion of the vaporized essential oil 30. However, the one or more nozzles 190 and a perforated hose 170 are merely illustrative of the vapor dispersing device 50, and it is within the scope of the present invention to include any device capable of dispersing a vaporized liquid.

Referring again to FIG. 1(a), a first pipe 200 extends from the first opening 130, and a second pipe 210 extends from the second opening 140. The first and second pipes 200 and 210 are in communication with the outlet pipe 70 so that air flowing from the outlet of the air blower 10 may be divided into two separate airflows, wherein one airflow flows through the first pipe 200 and wherein a second airflow flows through the second pipe 210. The outlet pipe 70 connects to the first and second pipes 200, 210 with a tee fitting 220, for example. A first bypass valve 230 is also disposed between the first and second pipes 200, 210 at a location between the tee fitting 220 and the first pipe 200. Additionally, a second bypass valve 235 may be disposed between the second pipe 210 and the fitting tee 220, as shown in FIG. 1(b). Alternately, the apparatus may include only the second bypass valve 235, as shown in FIG. 1(c). An air lance 240 extends into the interior of the reservoir 20 from the first opening 130 and is in communication with the first pipe 200. The air lance 240 includes a plurality of openings 250, providing communication between the interior of the air lance 240 and the interior of the reservoir 20.

As illustrated in FIGS. 1(a)-(c), 4, 5 and 6, the tee fitting 220 is located above the fill level of the oil 30 contained within the reservoir 20 to prevent the oil 30 from flowing into and damaging the air blower 10 via the air lance 240, the first pipe 200, the bypass valve 230, the tee fitting 220, and the outlet pipe 70. Standard pipefittings and couplings may be used to construct the present invention.

The air blower 10 also includes a motor (not shown), such as a TEFC (Totally Enclosed, Fan Cooled) motor, having a stock size, such as a ½ horsepower (HP), ¾ HP, 1 HP, 3 HP, or 5 HP motor, for example. The motor may include permanently sealed ball bearings, for example. An air blower 10 having a motor with a more powerful motor is capable of dispersing a greater volume of vaporized oil 30 during a given time period, whereas an air blower 10 having a motor with a less powerful motor disperses a lower volume of oil 30 during the same period of time. Additionally, the inlet and outlet of the air blower 10 is muffled so as to meet or exceed OSHA noise standards, for example.

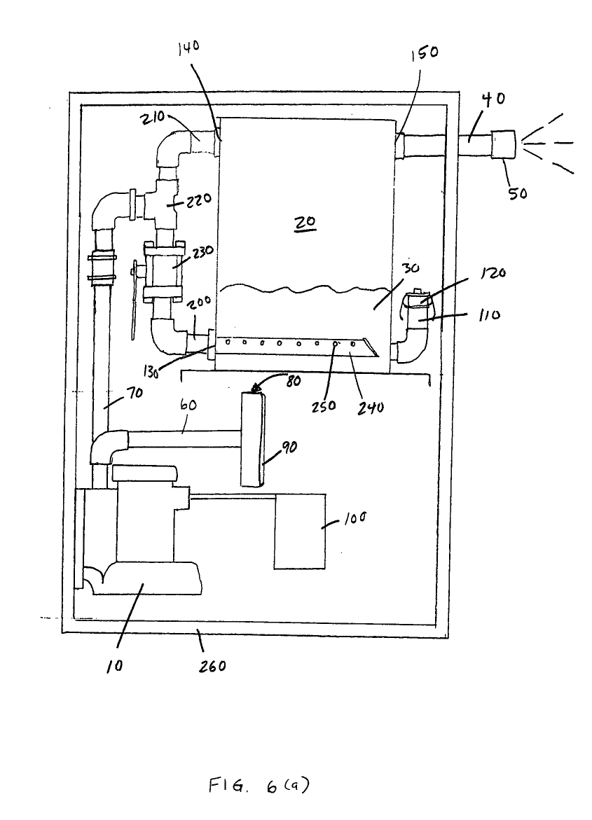

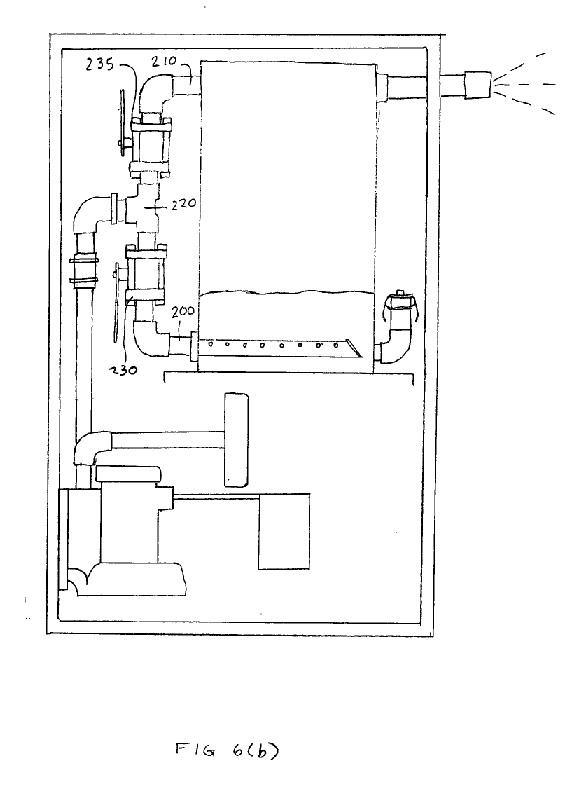

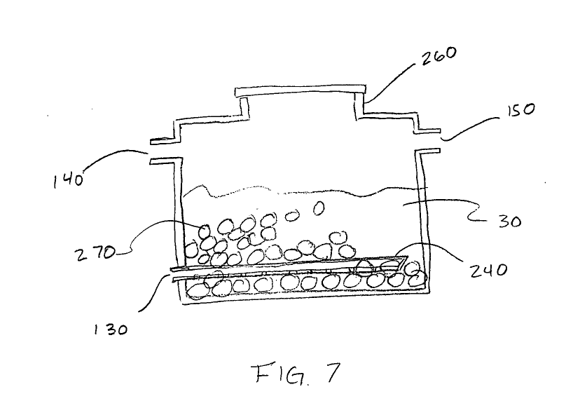

Referring to FIG. 4, the apparatus is configurable as a single unit within a housing 260, so as to be easily transportable from one location to another. Further, the apparatus may be oriented horizontally, for example, as shown in FIGS. 1(a)-(c), 4, and 5, or vertically, as shown in FIGS. 6(a) and (b). Additionally, although the bypass valve 230 is shown in FIGS. 4-6 as being below the tee fitting 220, it is within the scope of the invention to include the second bypass valve 235 between the second pipe 210 and the tee fitting 220, as shown in FIG. 6(b), or to include only the second bypass valve 235, as illustrated in FIG. 1(c).

In operation, the air blower 10 is switched on via the control panel 100 and draws outside air through the air filter 80 and air inlet pipe 60. The outside air, heated by the ordinary action of the air blower 10, is then forced through the outlet pipe 70 and through the tee fitting 220. Thereafter, the air may be directed entirely through the pipe 200. Alternatively, the air may be divided into two separate flows by adjusting the bypass valve 230 and/or the bypass valve 235. A first flow passes through the first pipe 200, the first opening 130, the air lance 240, and into the interior of the reservoir 20. A second flow passes through the second pipe 210, the second opening 140, and into the interior of the reservoir 20. The bypass valves 230 and 235 are adjustable so as to change the amount of air passing through the first and second pipes 200, 210. Therefore, once the apparatus is started, adjusting the bypass valves 230 and/or 235 controls a concentration of vaporized oil 30 discharged from the apparatus. Hence, the blower 10 can be operated at a constant speed, reducing the complexity of the apparatus.

Heated air entering through the second opening 140 passes into the interior of the reservoir 20 and over the surface of the oil 30, causing a portion of the air to vaporize. Alternately, heated air passing through the first opening 130 exits through the openings 250 formed in the air lance 240, such as in a bubbling manner, causing a portion of the oil 30 to vaporize. Consequently, the capability to redirect a portion of the heated air through the first pipe 200 by opening the bypass valve 230 causes evaporation of the oil 30 to occur at a higher rate, thereby increasing the concentration of the oil 30 exhausted from the apparatus.

Thereafter, a mixture of air and oil 30 (interchangeably referred to hereinafter as “mixture”) is discharged from the interior of the reservoir 20 through the outlet 150, where the mixture is dispersed via the vapor dispersing device 50.

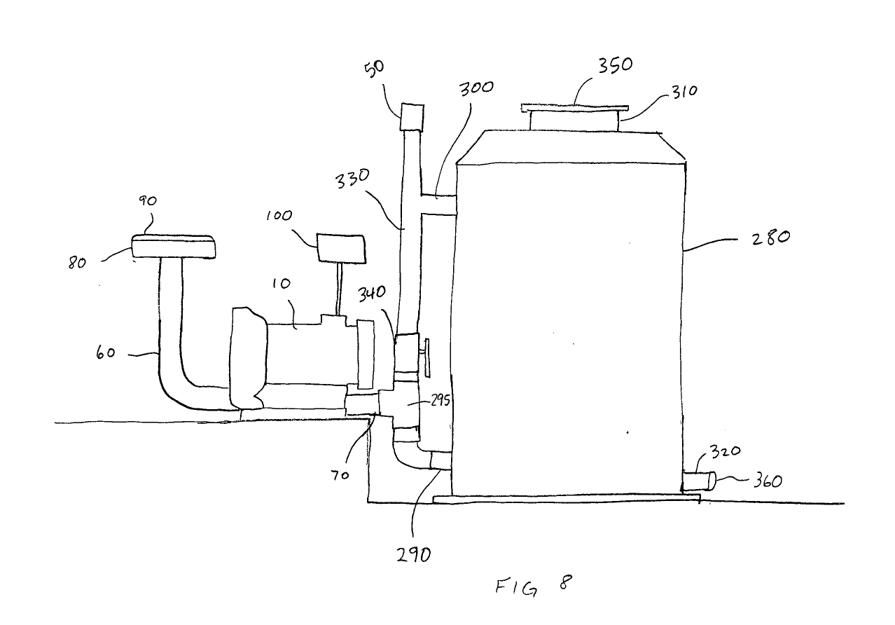

Referring to FIG. 7, the reservoir 20 alternatively includes a charge port 260 and a plurality of pack fill spheres 270 (interchangeably referred to hereinafter as “scrubber packing 270”), such as, for example, a plurality of 3.5-inch diameter polypropylene spheres. The scrubber packing 270 fills a portion of the interior of the reservoir 20 and creates obstructions to the air passing through the oil 30 and, consequently, increases the amount of time the air is in contact with the oil 30. As a result, the air evaporates a larger amount of the oil 30.

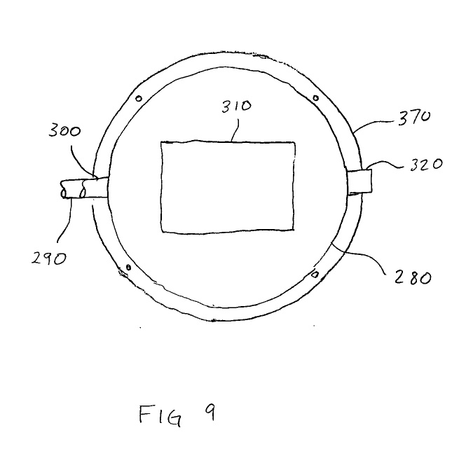

A second embodiment of the present invention is illustrated in FIG. 8. The apparatus includes a regenerative blower 10, similar to the type described above. As such, the blower 10 includes an air inlet pipe 60, an air outlet pipe 70, and a control panel 100. The blower 10 also includes a motor of any suitable size, such as those described above, to accommodate a desired flowrate of air, and the inlet pipe 60 includes, for example, an air filter 80, similar to the type described above. Further, the apparatus includes a reservoir 280 having an inlet pipe 290, an outlet pipe 300, a charging port 310, and a drain 320. The air outlet pipe 70 and the inlet pipe 290 are connected via a tee fitting 295, providing communication between the blower 10 and the interior of the reservoir 280. A bypass pipe 330 extends between the inlet pipe 290 and the outlet pipe 300 and includes a bypass valve 340. The bypass valve 340 directs all or only a portion of the air into the reservoir 280 through the inlet pipe 290. Although not shown, the apparatus according to the second embodiment may also include a second bypass valve disposed between the tee fitting 295 and the inlet pipe 290. The second bypass valve is also used to control an amount of air directed into the interior of the reservoir 280 and an amount of air directed through the bypass pipe 330. Further, the apparatus according to the second embodiment may include only the second bypass valve. The charging port 310 includes a removable lid 350, which permits access to the interior of the reservoir 280 for introduction of items, such as scrubber packing 270 and oil 30, for example. The drain 320 includes a removable lid 360 that, when removed, allows any fluid within the reservoir 280 to drain.

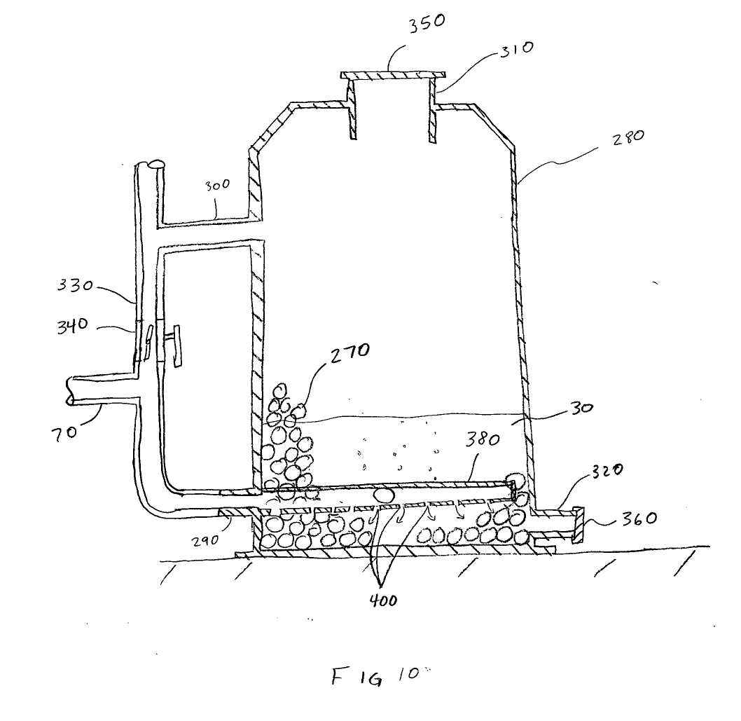

As shown in FIGS. 8 and 9, the reservoir 280 is cylindrical and includes an annular flange 370 for securing the reservoir 280 to a structure. However, it is within the scope of the present invention that the reservoir 280 have any suitable shape, such as a cube, a rectangular box, sphere, pyramid, or tetrahedron.

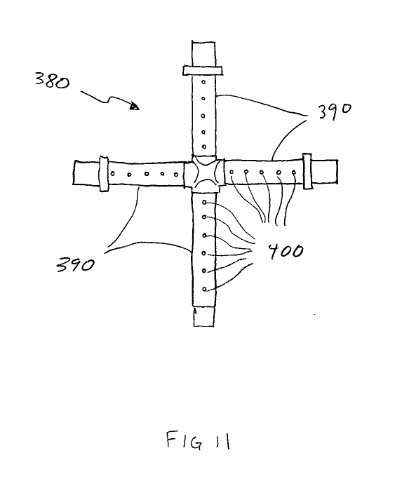

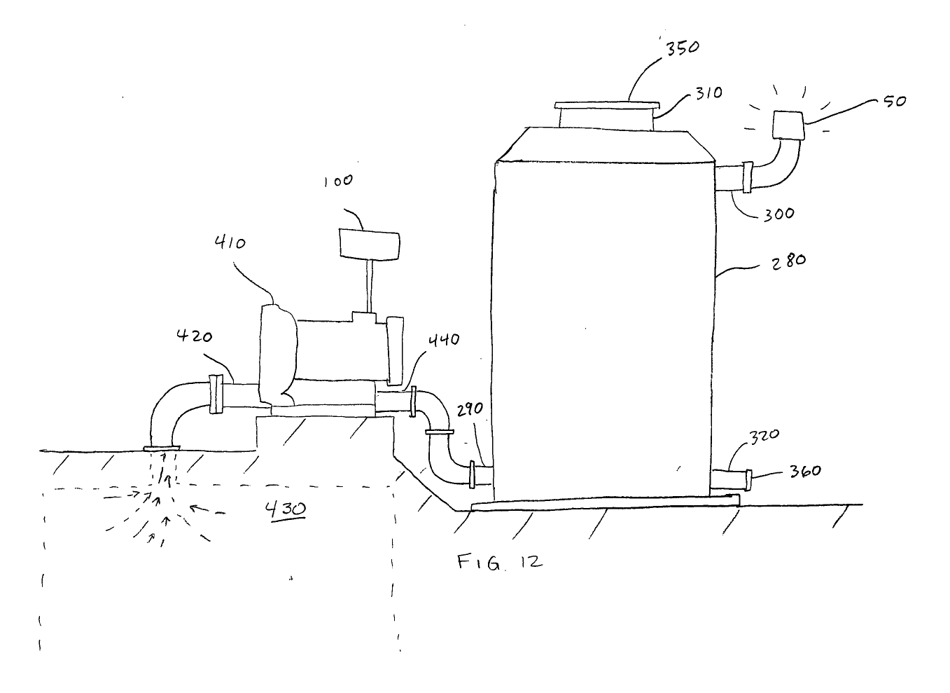

Referring to FIGS. 10 and 11, an air sparger 380 having a plurality of branches 390 is disposed within the interior of the reservoir 280 and is attached at one end to the inlet pipe 290. For example, as shown in FIG. 11, the air sparger 380 is cross-shaped and includes four branches 390. However, the cross-shaped air sparger 380 is shown only as an example, and it is within the scope of the present invention to include an air sparger of any shape or configuration or having any number of branches 390. The air sparger 380 also includes a plurality of openings 400 formed along each branch 390 in a bottom surface thereof, for example. The openings 400 provide communication between the interior of the reservoir 280 and the outlet of the blower 10. Further the blower 10 and the outlet pipe 70 are disposed above the fill level of the oil 30 so that the oil 30 does not flow into the blower 10.

During operation of the apparatus, ambient air drawn through the air filter 80 and inlet pipe 60 passes through the blower 10 and the air outlet pipe 70. As explained above, all or a portion of the air is directed into the reservoir 20 and through the air sparger 380 by manipulation of the bypass valve 340. The remainder of the air (i.e., bypass air) is directed through the bypass valve 340 and the bypass pipe 330. Therefore, positioning of bypass valve 340 controls an amount of air coming into contact with the oil 30. Consequently, the blower 10 can be operated at a constant speed, reducing the complexity of the apparatus.

The portion of air directed into the reservoir 280 exits the plurality of openings 400 and bubbles through the oil 30 and around the scrubber packing 270, if present. As explained above, the air evaporates a portion of the oil 30 forming an air/oil mixture. The mixture exits the reservoir 280 through the outlet pipe 300, combines with the bypass air, if any, and exits the apparatus through a vapor dispersing device 50. As explained above, the vapor dispersing device 50 can include the perforated hose 170 (shown in FIG. 2) or one or more nozzles 90 (shown in FIGS. 3 and 5), for example.

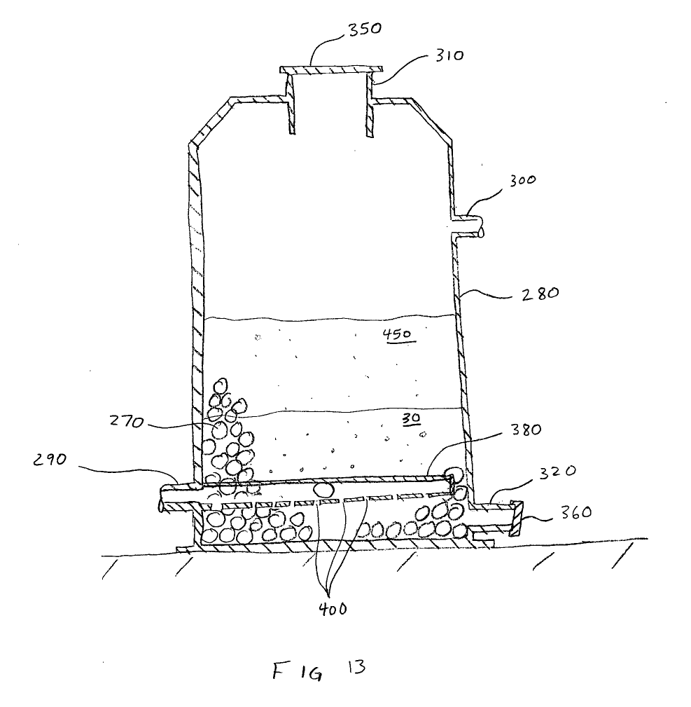

FIGS. 12 and 13 illustrate a third embodiment of the present invention. The apparatus according to the third embodiment includes a vacuum pump 410 connected to a reservoir 280. A vacuum pump 410 may be used as opposed to a regenerative blower, because the air need not be warmed during pumping. However, a regenerative blower may be used, and, as such, the present invention is inclusive of both a vacuum pump and regenerative blower.

An inlet pipe 420 of the vacuum pump 410 attaches to a mating pipe or fitting of a source 430, such as an outlet of a wastewater pumping station. An outlet pipe 440 of the vacuum pump 390 connects to an inlet pipe 290 of the reservoir 280. As described above, the reservoir 280 includes an outlet pipe 300, a charging port 310, and a drain 320. Although illustrated as being cylindrical in shape, the reservoir 280 can be of any suitable shape, as in the previous embodiments. An air sparger 380, having a plurality of openings 400, is disposed within the reservoir 280 and is in communication with the inlet pipe 290. As also explained above, although the air sparger 380 is illustrated as being cross-shaped, the air sparger may have any suitable shape or configuration.

The interior of the reservoir 280 contains a scavenger fluid 450, an oil 30, and scrubber packing 270, for example. The scavenger fluid 450 includes, for example, bleach, caustic (e.g., NaOH), trizene, or any other fluid capable of removing obnoxious or undesired gases from an airflow, such as H₂S. Further, the scavenger fluid 450 has a different density than the essential oil 30, so that the scavenger fluid 450 and the essential oil 30 form separate layers within the reservoir 280. The scavenger fluid 450, the oil 30, and the scrubber packing 270 are introduced into the reservoir via the charging port 310.

The apparatus is activated using a control panel 100, which causes the vacuum pump 410 to draw air from the desired source 430. The air passes from the vacuum pump 410 and into the reservoir 280 via the air outlet 440, the air inlet 290 of the reservoir 280, and the air sparger 380. The air then exits the air sparger 380 and bubbles through the scavenger fluid 450 and the oil 30. As explained above, the scrubber packing 270 creates obstructions to the flow of the air and, therefore, increases the amount of time the air is present within the scavenger fluid 450 and the oil 30. The scavenger fluid 450 reacts with and removes H₂S contained in the air. The air then evaporates a portion of the oil 30 before the mixture of air and oil 30 is released into the atmosphere. As a result, the air is deodorized. The mixture is dispersed into the atmosphere by a vapor dispersing device 50, such as the perforated hose 170 (shown in FIG. 2) or the one or more nozzles 90 (shown in FIGS. 3 and 5).

The apparatus according to the third embodiment may also include a bypass pipe connected to the air outlet 440 and one or more bypass valves, as described above, for directing a portion of the air outside of the reservoir 280.

Example uses of the present invention include deodorizing an air flow generated by pumping waste material from a septic tank or other waste facility to a tank, such as a tank mounted on a truck. Additionally, the present invention is useable to deodorize an air flow emitted from a pump house of a wastewater treatment plant. Accordingly, it is within the scope of the present invention that the apparatus be portable, such as transportable by truck, to a preferred location or permanently mounted at a particular location.

While there has been described what are at present considered to be preferred embodiments of the present invention, it will be understood that various modifications may be made thereto, and it is intended that the appended claims cover all such modifications as fall within the true spirit and scope of the invention. Other modifications will be apparent to those skilled in the art.

What is claimed is:

1. A method of waterless dispersion of essential oil comprising:
blowing a first gas stream through a volume of essential oil;
entraining a portion of the volume of essential oil to form a first entrained gas; and
dispersing the first entrained gas into an open space.

2. The method according to claim 1 further comprising:
blowing a second gas stream over a surface of the volume of essential oil;
entraining a portion of the volume of essential oil to form a second entrained gas; and
dispersing the second entrained gas into an open space.

3. The method according to claim 2 further comprising separating a gas flow into the first gas stream and the second gas stream.

4. The method according to claim 3, wherein a valve separates the gas flow into the first gas stream and the second gas stream.

5. The method according to claim 3 further comprising controlling a size of the first gas stream and the second gas stream with a valve.

6. The method according to claim 1 further comprising controlling an amount of gas blowing through the volume of essential oil by bypassing a portion of the first gas stream away from the volume of essential oil.

7. The method according to claim 6, wherein a valve is used to bypass the portion of the first gas stream away from the volume of essential oil.

8. The method according to claim 1, wherein the first gas stream is simultaneously heated and blown by a regenerative air blower.

9. The method according to claim 1, further comprising blowing the first gas stream through a scavenger fluid.

10. The method according to claim 9, wherein the scavenger fluid and the essential oil have different densities.

11. The method according to claim 9, wherein scavenger fluid is selected from a group consisting of bleach, NaOH, and trizene.

12. The method according to claim 9, wherein the first gas stream is blown by a vacuum pump.

13. The method according to claim 9 further comprising increasing an amount of time the first gas stream flows through the scavenger fluid by flowing the first gas stream around a plurality of objects disposed in the scavenger fluid.

14. The method according to claim 1 further comprising increasing an amount of time the first gas stream flows through the volume of essential oil by flowing the first gas stream around a plurality of objects disposed in the volume of essential oil.

15. The method according to claim 1 further comprising containing the volume of essential oil in a reservoir.

16. The method according to claim 15 further comprising blowing the first gas stream through the volume of essential oil contained in the reservoir.

17. The method according to claim 16 further comprising bubbling the first gas stream through the volume of essential oil by passing the first gas stream through a plurality of openings formed in an air sparger disposed in the reservoir.

18. The method according to claim 2 further comprising containing the volume of essential oil in a reservoir.

19. The method according to claim 18 further comprising blowing the first gas stream and the second gas stream through the reservoir.

20. The method according to claim 19 further comprising bubbling the first gas stream through the volume of essential oil by passing the first gas stream through a plurality of openings formed in an air sparger that is disposed in the reservoir.

21. The method according to claim 2, wherein the first gas stream and the second gas stream are simultaneously heated and blown by a regenerative air blower.

22. The method according to claim 2 further comprising combining the first entrained gas and the second entrained gas before dispersing the first entrained gas and the second entrained gas into the open space.

23. The method according to claim 5, wherein the open space is outdoors.

24. The method according to claim 5, wherein the open space is a large enclosed space.

25. An apparatus for deodorizing and dispersing a gas stream comprising:
a gas-pumping device having an inlet and an outlet;
a deodorizing liquid having a liquid surface; and
a reservoir containing the deodorizing liquid, the reservoir comprising:
a first inlet below the liquid surface of the deodorizing liquid; and
an outlet above the surface of the volume of essential oil;
wherein the outlet of the gas-pumping device is in communication with the first inlet of the reservoir.

26. The apparatus according to claim 25, wherein the gas-pumping device is a regenerative air blower.

27. The apparatus according to claim 25, wherein the reservoir further comprises a second inlet above the liquid surface and wherein the second inlet of the reservoir is in communication with the outlet of the gas-pumping device.

28. The apparatus according to claim 27, wherein a bypass valve is disposed between the first inlet of the reservoir and the second inlet of the reservoir.

29. The apparatus according to claim 25 further comprising a vapor distribution device attached to the outlet of the reservoir.

30. The apparatus according to claim 29, wherein the vapor distribution device is at least one nozzle.

31. The apparatus according to claim 29, wherein the vapor distribution device is a length of perforated hose.

32. The apparatus according to claim 25 further comprising a plurality of scrubber packing spheres disposed within the reservoir.

33. The apparatus according to claim 25, wherein the deodorizing liquid is an essential oil.

34. The apparatus according to claim 25, wherein the inlet of the gas-pumping device is open to the atmosphere.

35. The apparatus according to claim 25 further comprising a gas distribution device disposed within the reservoir, wherein the interior of the gas distribution device is in communication with the first inlet of the reservoir and the interior of the reservoir.

36. The apparatus according to claim 35, wherein the gas distribution device includes a plurality of openings which provide the communication between the interior of the gas distribution device and the interior of the reservoir.

37. The apparatus according to claim 25 further comprising a scavenging fluid disposed within the reservoir.

38. The apparatus according to claim 37, wherein the scavenger fluid and the essential oil have different densities.

39. The apparatus according to claim 37, wherein the scavenging fluid is selected from a group consisting of bleach, NaOH, and trizene.

40. The apparatus according to claim 37 further comprising a bypass line for bypassing at least a portion of an output of the gas-pumping device to the exterior of the reservoir, wherein a first end of the bypass line communicates with the outlet of the gas-pumping device.

41. The apparatus according to claim 40, wherein the bypass line communicates with the output of the reservoir.

42. The apparatus according to claim 37 further comprising a plurality of scrubber packing spheres disposed within the reservoir.

43. The apparatus according to claim 37, wherein the gas-pumping device is a vacuum pump.

44. The apparatus according to claim 37 further comprising a vapor distribution device attached to the outlet of the reservoir.

45. The apparatus according to claim 44, wherein the vapor distribution device is at least one nozzle.

46. The apparatus according to claim 44, wherein the vapor distribution device is a length of perforated hose.

47. The apparatus according to claim 40 further comprising a bypass valve disposed between the outlet of the gas-pumping device and the bypass line.

48. The apparatus according to claim 37 further comprising a gas distribution device disposed within the reservoir, wherein the interior of the gas distribution device communicates with the first inlet of the reservoir and the interior of the reservoir.

49. The apparatus according to claim 48, wherein the gas distribution device includes a plurality of openings which provide the communication between the interior of the gas distribution device and the interior of the reservoir.
